(19) United States
(12) Patent Application Publication
(10) Pub. No.: US 2020/0364001 A1
(43) Pub. Date: Nov. 19, 2020

(54) IDENTICAL WORKLOADS CLUSTERING IN VIRTUALIZED COMPUTING ENVIRONMENTS FOR SECURITY SERVICES

(71) Applicant: VMWARE, INC., Palo Alto, CA (US)

(72) Inventors: Vaibhav BHANDARI, Pune (IN); Darshika KHANDELWAL, Pune (IN); Ujwala KAWALAY, Pune (IN); Prashant AMBARDEKAR, Pune (IN); Prayas GAURAV, Pune (IN)

(21) Appl. No.: 16/544,946

(22) Filed: Aug. 20, 2019

(30) Foreign Application Priority Data
May 15, 2019 (IN) 201941019391

(51) Int. Cl. G06F 3/06; G06F 9/455

(52) U.S. Cl. CPC G06F 3/0662; G06F 3/0646; G06F 3/0613; G06F 2009/45587; G06F 9/45533; G06F 2009/4557; G06F 3/067

(57) ABSTRACT

In one example, workload attributes associated with workloads running in a virtualized computing environment may be retrieved. A distance analysis may be performed using the retrieved workload attributes to generate a distance matrix that identifies a distance between each workload and each other workload. Further, a cluster analysis may be performed on the workloads based on the distance matrix to generate clusters, where each cluster may include identical workloads. Furthermore, the identical workloads in each cluster may be associated with at least one security policy to provide security services in the virtualized computing environment.

### RELATED APPLICATIONS

Benefit is claimed under 35 U.S.C. 119(a)-(d) to Foreign Application Serial No. 201941019391 filed in India entitled “IDENTICAL WORKLOADS CLUSTERING IN VIRTUALIZED COMPUTING ENVIRONMENTS FOR SECURITY SERVICES”, on May 15, 2019, by VMWARE, Inc., which is herein incorporated in its entirety by reference for all purposes.

### TECHNICAL FIELD

The present disclosure relates to computing environments, and more particularly to methods, techniques, and systems for clustering identical workloads to provide security services in a virtualized computing environment.

### BACKGROUND

Computer virtualization may be a technique that involves encapsulating a representation of a physical computing machine platform into a workload (e.g., virtual machine (VM), container, and the like) that may be executed under the control of virtualization software running on hardware computing platforms. A virtual machine can be a software-based abstraction of the physical computer system. Each virtual machine may be configured to execute an operating system (OS), referred to as a guest OS, and applications. The containers may refer to software instances that enable virtualization at the OS level. In such virtualized computing environments, security requirements may vary based on workloads. For example, workloads acting as management nodes may require different security policy configuration than workloads running test machines and/or non-production workloads. In such scenarios, virtual machines and/or containers may be secured by adding them to security groups and applying firewall rules on those security groups based on the security requirements.

### BRIEF DESCRIPTION OF THE DRAWINGS

FIG. 1 is a block diagram of an example virtualized computing environment, including a workload classification unit for clustering identical workloads to provide security services;

FIG. 2 is a sequence diagram illustrating sequence of events to cluster identical workloads for facilitating security services in a virtualized computing system.

FIG. 3 is an example flow diagram illustrating clustering identical workloads to associate security policies; and

FIG. 4 is a block diagram of an example computing device including non-transitory computer-readable storage medium storing instructions to cluster identical workloads to provide security services in a virtualized computing environment.

The drawings described herein are for illustration purposes only and are not intended to limit the scope of the present subject matter in any way.

### DETAILED DESCRIPTION

Examples described herein may provide an enhanced computer-based and network-based method, technique, and system for clustering identical workloads to provide security services in a virtualized computing environment. The virtualized computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtualized computing environment may be a virtual representation of a physical data center, complete with servers, storage clusters, and networking components, all of which may reside in virtual space being hosted by one or more physical data centers.

Further, the virtualized computing environment may include multiple hosts (i.e., physical host computing systems) executing workloads (e.g., virtual machines (VMs)) and/or containers) running therein. Example host computing system may be a physical computer. The virtual machines, in some examples, may operate with their own guest operating systems on a host computing system using resources of the host computing system virtualized by virtualization software (e.g., a hypervisor, virtual machine monitor, and the like). The containers may refer to software instances that enable virtualization at an operating system (OS) level. Furthermore, security requirements of the workloads may vary in the virtualized computing environment. For example, workloads acting as management nodes may require different policy configuration than workloads running test machines and/or non-production workloads.

In some examples, virtual networking and security software solution (e.g., NSX® of VMware®) may secure the workloads by adding the workloads to different security groups and applying firewall rules to the security groups. In large enterprise datacenters, the number of workloads that the users deal with is humongous. In such cases, manual addition of each of the workloads to the security groups may be challenging for a security administrator as the security administrator may require domain knowledge, knowledge of the network topology, and the like. Further, when a task of adding a workload to a security group is overlooked, it may lead to security issues as relevant firewall rules may not be applied to the workload.

Examples described herein may intelligently identify workloads with similar or identical configuration using machine learning and automatically assign corresponding security policies to the identical workloads. Examples described herein may perform a distance analysis and a cluster analysis on the workloads to cluster the identical workloads in the virtualized computing environment. Further, the identical workloads in each cluster are associated with at least one security policy to provide security services in the virtualized computing environment. Thus, examples described herein may automate the task for a security administrator and improve the security posture of the workloads in the virtualized computing environment.

System Overview and Examples of Operation

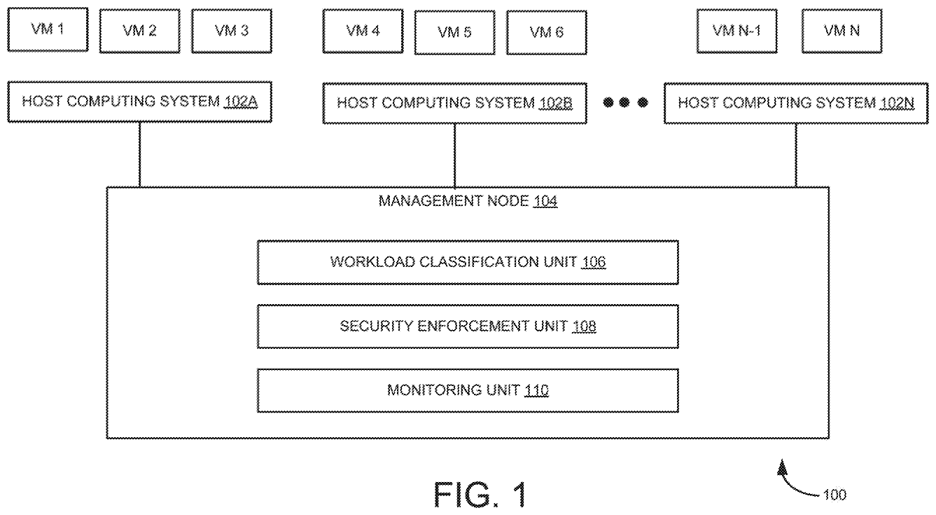

FIG. 1 is a block diagram of an example virtualized computing environment 100, including a workload classification unit 106 to cluster identical workloads for provide security services. As shown in FIG. 1, virtualized computing environment 100 may include multiple host computing systems 102A-102N, each executing corresponding ones of workloads (e.g., virtual machines VM 1 to VM N). Example host computing system (e.g., 102A-102N) may be a physical computer. The physical computer may be a hardware-based device (e.g., a personal computer, a laptop, or the like) including an operating system (OS). A virtual machine (e.g., VM 1 to VM N) may operate with its own guest OS on the physical computer using resources of the physical computer virtualized by virtualization software (e.g., a hypervisor, a virtual machine monitor, and the like).

Further, virtualized computing environment 100 may include a management node 104 communicatively coupled to host computing systems 102A-102N via a network. Example network can be a managed Internet protocol (IP) network administered by a service provider. For example, the network may be implemented using wireless protocols and technologies, such as WiFi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

As shown in FIG. 1, management node 104 may include workload classification unit 106 to retrieve workload attributes associated with workloads (e.g., VM1 1 to VM N) running in virtualized computing environment 100. In one example, the workload attributes may correspond to at least one parameter such as workload parameters, operating system parameters, applications running inside workloads, and partner provided attributes for the workloads. Further, workload classification unit 106 may perform a distance analysis using the retrieved workload attributes to generate a distance matrix that identifies a distance between each workload (e.g., VM 1) and each other workload (VM 2 to VM N). Example distance analysis may include a Levenshtein algorithm or the like. Furthermore, workload classification unit 106 may perform a cluster analysis on the workloads (e.g., VM 1 to VM N) based on the distance matrix to generate clusters. For example, each cluster may include identical workloads. Example cluster analysis may include one of a Gaussian-means cluster, an affinity propagation, and the like.

Further, management node 104 may include a security enforcement unit 108 communicatively coupled to workload classification unit 106 to associate the identical workloads in each cluster with at least one security policy to provide security services in virtualized computing environment 100. In one example, security enforcement unit 108 may apply the at least one security policy to the identical workloads in each cluster. For example, security policies may include access control lists (ACLs), firewalls, encryption policies, or any combination thereof.

As shown in FIG. 1, management node 104 may include a monitoring unit 110 to monitor the workload attributes associated with the workloads (e.g., VM 1 to VM N). For example, when there is a change in a workload attribute associated with a workload (e.g., VM 1), the at least one security policy associated with the workload (e.g., VM 1) may be reevaluated. In one example, reevaluation may be performed by repeating the steps of performing the distance analysis and the cluster analysis (e.g., by workload classification unit 106) to determine a cluster in which the workload (VM 1) to be grouped based on the change in the workload attribute.

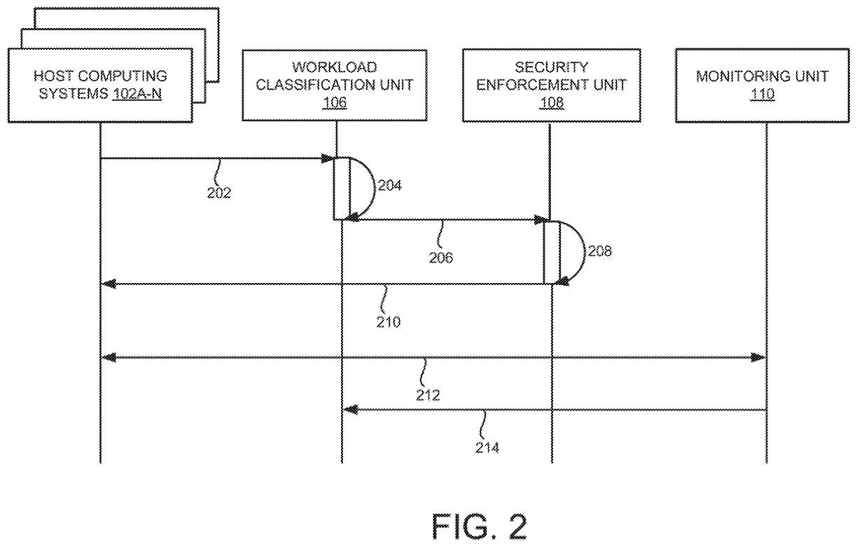

FIG. 2 is a sequence diagram illustrating sequence of events to cluster identical workloads for facilitating security services in a virtualized computing system. For example, similarly named elements of FIG. 2 may be similar in structure and/or function to elements described with respect to FIG. 1. The sequence diagram may represent the interactions and the operations involved in clustering the identical workloads and associating corresponding security policies. FIG. 2 illustrates process objects including host computing systems 102A-N, workload classification unit 106, security enforcement unit 108, and monitoring unit 110 along with their respective vertical lines originating from them. The vertical lines of host computing systems 102A-N, workload classification unit 106, security enforcement unit 108, and monitoring unit 110 may represent the processes that may exist simultaneously. The horizontal arrows (e.g., 202, 206, 210, 212, and 214) may represent the data flow steps between the vertical lines originating from their respective process objects (for e.g., host computing systems 102A-N, workload classification unit 106, security enforcement unit 108, and monitoring unit 110). Further, activation boxes (e.g., 204 and 208) between the horizontal arrows may represent the process that is being performed in the respective process object.

At 202, workload classification unit 106 may retrieve workload attributes associated with workloads running in a virtualized computing environment. In one example, workload classification unit 106 may retrieve workload attributes from the workloads running on host computing systems 102A-N. In another example, the workload attributes may be stored in a repository and workload classification unit 106 may retrieve the workload attributes from the repository. For example, the workload attributes may correspond to parameters selected from a group consisting of workload parameters, operating system parameters, applications running inside workloads, and partner provided attributes for workloads. Example workload parameters may include host computing systems information, name of the workloads, datastores, port groups, and the like. Example operating system parameters are operating system type, hostname, central processing unit (CPU), memory type, storage type, and the like. Example partner provided attributes for the workloads may be workloads having sensitive data, workloads including virus infected files, and the like. Further, multiple workload specific parameters such as application and infrastructure metrics may be used as input to machine learning algorithms used by workload classification unit 106.

For example, virtual machine name may be a workload attribute as the virtual machine name may provide the intent of usage of the virtual machine. Number of CPUs in a virtual machine may be another workload attribute as the number of CPUs may distinguish high powered virtual machines requiring more security from low powered virtual machines. Further, a number of virtual network interface controllers (vNICs) of the virtual machine may be yet another workload attribute. When there are couple of vNICs in the virtual machine, the virtual machine may be considered important as the virtual machine is provided with redundant set of vNICs. Also, applications running on the virtual machines may be another example of workload attributes. For example, based on the application running on the virtual machines, similar virtual machines can be clustered together.

At 204, workload classification unit 106 may perform a distance analysis using the retrieved workload attributes to generate a distance matrix that identifies a distance between each workload and each other workload of the workloads. Further, workload classification unit 106 may perform a cluster analysis on the workloads based on the distance matrix to generate clusters. Further, each cluster may include the identical workloads with similar configurations based on the workload attributes.

Example cluster analysis may include one of a Gaussian-means (G-means) cluster, an affinity propagation, and the like. G-means clustering algorithm may be an extension of k-means clustering algorithm to determine an appropriate number of clusters (e.g., k). The G-means algorithm may begin with a small number of k-means centers and increases the number of centers. Each iteration of the algorithm may split into two those centers whose data appear not to come from a Gaussian distribution. Further, between each round of splitting, k-means cluster may be applied on the entire dataset. In one example, the value of k may be initialized as l or other value may be specified for k if an administrator is aware about the range of k.

In statistics and data mining, affinity propagation (AP) is a clustering algorithm based on the concept of message passing between data points. Further, the affinity propagation may not require the number of clusters to be determined or estimated before running the algorithm. The affinity propagation may find exemplars, members of the input set that are representative of clusters. Further, to apply affinity propagation for determining the identical workloads, the distance between two workloads may be determined using the Levenshtein distance. The Levenshtein distance may include the minimum number of edit operations necessary for transforming one sequence into the other. Example edit operations allowed are shown below:
deletion: ABC->BC, AC, AB
insertion: ABC->ABCD, EABC, AEBC
substitution: ABC->ABE, ADC, FBC

For example, the workload attribute “names of virtual machines” may be provided to the affinity propagation and the Levenshtein distance as an input. Example input is shown below:
pnq-dev-1
pal-test-2
pnq-dev-23
pal-test-3

Where, “pnq-dev-1”, “pal-test-2”, “pnq-dev-23”, and “pal-test-3” may refer to names of virtual machines. Further, the input may be sent to the Levenshtein distance and the affinity propagation. The outcome or result of the Levenshtein distance and the affinity propagation may segregate the four virtual machines into two groups (“*pnq-dev-23:*” and “*pal-test-3:*”) as shown below:
*pnq-dev-23:* pnq-dev-1, pnq-dev-23
*pal-test-3:* pal-test-2, pal-test-3

Thus, the virtual machines “pnq-dev-1” and “pnq-dev-23” may be clustered as the identical workloads. Further, virtual machines “pal-test-2” and “pal-test-3” may be clustered as the identical workloads.

In another example, virtual machines having names including word “windows” may be clustered as the identical workloads. Further, the virtual machines where a partner has applied “VIRUS FOUND” tag may be clustered as the identical workloads. Also, list of virtual machines having one or more network interface connected to port group “portgroup 123” may be clustered as the identical workloads.

At 206, security enforcement unit 108 may receive information of identical workloads in each of the clusters. At 208, security enforcement unit 108 may associate the identical workloads in each cluster with at least one security policy to provide security services to corresponding clusters in the virtualized computing environment. At 210, security enforcement unit 108 may apply the at least one security policy to the identical workloads in each cluster. An example security enforcement unit 108 may be implemented using, for example, the VMware NSX®.

At 212, monitoring unit 110 may monitor the workload attributes associated with the workloads. In one example, when there is a change in a workload attribute associated with a workload, monitoring unit 110 may instruct workload classification unit 106 to reevaluate the at least one security policy associated with the workload, at 214. Further, workload classification unit 106 may repeat the steps of performing the distance analysis and the cluster analysis to determine a cluster in which the workload to be grouped based on the change in the workload attribute. Furthermore, security enforcement unit 108 may assign a new security policy based on the determined cluster.

In some examples, the functionalities described herein, in relation to instructions to implement functions of workload classification unit 106, security enforcement unit 108, monitoring unit 110, and any additional instructions described herein in relation to the storage medium, may be implemented as engines or modules comprising any combination of hardware and programming to implement the functionalities of the modules or engines described herein. The functions of application of workload classification unit 106, security enforcement unit 108, and monitoring unit 110 may also be implemented by a respective processor. In examples described herein, the processor may include, for example, one processor or multiple processors included in a single device or distributed across multiple devices.

### Example Processes

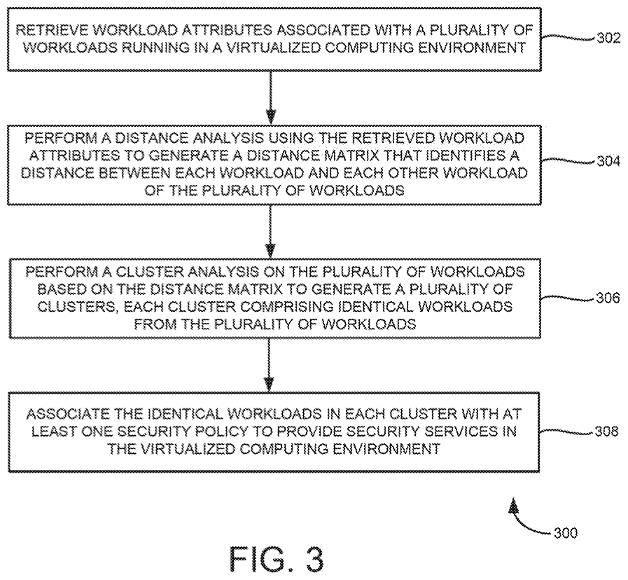

FIG. 3 is an example flow diagram 300 illustrating clustering identical workloads to associate security policies in a virtualized computing environment. It should be understood that the process depicted in FIG. 3 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 302, workload attributes associated with a plurality of workloads running in a virtualized computing environment may be retrieved. In one example, each of the plurality of workloads may include one of a virtual machine and a container. The workload attributes may correspond to parameters selected from a group consisting of workload parameters, operating system parameters, applications running inside workloads, and partner provided attributes for workloads. At 304, a distance analysis may be performed using the retrieved workload attributes to generate a distance matrix that identifies a distance between each workload and each other workload of the plurality of workloads. In one example, the distance analysis may include a Levenshtein algorithm or the like.

At 306, a cluster analysis may be performed on the plurality of workloads based on the distance matrix to generate a plurality of clusters, each cluster comprising identical workloads from the plurality of workloads. In one example, each cluster may include the identical workloads with similar configurations based on the workload attributes. Example cluster analysis may include one of a Gaussian-means cluster, an affinity propagation, and the like. At 308, the identical workloads in each cluster may be associated with at least one security policy to provide security services in the virtualized computing environment. In one example, the at least one security policy may be applied to the identical workloads in each cluster.

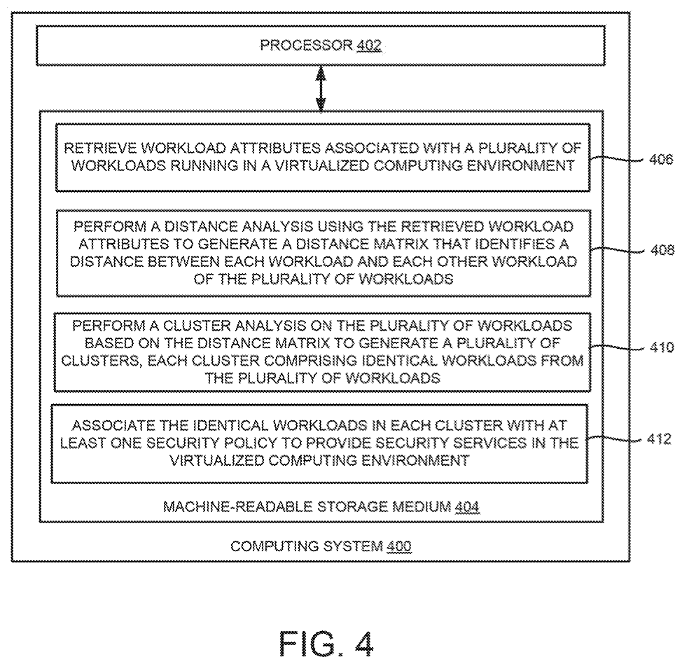

FIG. 4 is a block diagram of an example computing device 400 including non-transitory computer-readable storage medium storing instructions to cluster identical workloads to provide security services in a virtualized computing environment. Computing system 400 may include a processor 402 and a machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to computing system 400.

Machine-readable storage medium 404 may store instructions 406-412. In an example, instructions 406-412 may be executed by processor 402 for clustering the identical workloads to provide security services in the virtualized computing environment. Instructions 406 may be executed by processor 402 to retrieve workload attributes associated with a plurality of workloads running in the virtualized computing environment. Instructions 408 may be executed by processor 402 to perform a distance analysis using the retrieved workload attributes to generate a distance matrix that identifies a distance between each workload and each other workload of the plurality of workloads. Instructions 410 may be executed by processor 402 to perform a cluster analysis on the plurality of workloads based on the distance matrix to generate a plurality of clusters, each cluster comprising identical workloads from the plurality of workloads. Further, instructions 412 may be executed by processor 402 to associate the identical workloads in each cluster with at least one security policy to provide security services in the virtualized computing environment.

Examples described herein may be suitable for large scale deployments such as VMware Cloud Foundation™, which is commercially available from VMware. Examples described in FIGS. 1-4 can be implemented in vCenter Server™ and vSphere® program products, which are commercially available from VMware. Examples described herein can also be implemented in vRealize Automation®, vRealize Operations, vRealize Business, vCloud Automation Center, and/or the like that are offered by VMware.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A non-transitory machine-readable storage medium encoded with instructions that, when executed by a processor of a computing system, cause the processor to:
retrieve workload attributes associated with a plurality of workloads running in a virtualized computing environment;
perform a distance analysis using the retrieved workload attributes to generate a distance matrix that identifies a distance between each workload and each other workload of the plurality of workloads;
perform a cluster analysis on the plurality of workloads based on the distance matrix to generate a plurality of clusters, each cluster comprising identical workloads from the plurality of workloads; and
associate the identical workloads in each cluster with at least one security policy to provide security services in the virtualized computing environment.

2. The non-transitory machine-readable storage medium of claim 1, further comprising instructions that, when executed by the processor of the computing system, cause the processor to:
apply the at least one security policy to the identical workloads in each cluster.

3. The non-transitory machine-readable storage medium of claim 1, wherein each of the plurality of workloads comprises one of a virtual machine and a container.

4. The non-transitory machine-readable storage medium of claim 1, wherein the workload attributes correspond to parameters selected from a group consisting of workload parameters, operating system parameters, applications running inside workloads, and partner provided attributes for workloads.

5. The non-transitory machine-readable storage medium of claim 1, wherein the distance analysis comprises a Levenshtein algorithm.

6. The non-transitory machine-readable storage medium of claim 1, wherein the cluster analysis comprises one of a Gaussian-means cluster and an affinity propagation.

7. The non-transitory machine-readable storage medium of claim 1, wherein each cluster comprising the identical workloads with similar configurations based on the workload attributes.

8. The non-transitory machine-readable storage medium of claim 1, further comprising instructions that, when executed by the processor of the computing system, cause the processor to:
monitor the workload attributes associated with the plurality of workloads; and
when there is a change in a workload attribute associated with a workload, reevaluate the at least one security policy associated with the workload by repeating the steps of performing the distance analysis and the cluster analysis to determine a cluster in which the workload to be grouped based on the change in the workload attribute.

9. A management node comprising:
a workload classification unit to:
retrieve workload attributes associated with a plurality of workloads running in a virtualized computing environment;
perform a distance analysis using the retrieved workload attributes to generate a distance matrix that identifies a distance between each workload and each other workload of the plurality of workloads; and
perform a cluster analysis on the plurality of workloads based on the distance matrix to generate a plurality of clusters, each cluster comprising identical workloads from the plurality of workloads; and
a security enforcement unit communicatively coupled to the workload classification unit to:
associate the identical workloads in each cluster with at least one security policy to provide security services in the virtualized computing environment.

10. The management node of claim 9, wherein the security enforcement unit is to:
apply the at least one security policy to the identical workloads in each cluster.

11. The management node of claim 9, further comprising:
a monitoring unit to:
monitor the workload attributes associated with the plurality of workloads; and
when there is a change in a workload attribute associated with a workload, repeat, by the workload classification unit, the steps of performing the distance analysis and the cluster analysis to determine a cluster in which the workload to be grouped based on the change in the workload attribute.

12. The management node of claim 9, wherein each of the plurality of workloads comprises one of a virtual machine and a container.

13. The management node of claim 9, wherein the workload attributes correspond to parameters selected from a group consisting of workload parameters, operating system parameters, applications running inside workloads, and partner provided attributes for workloads.

14. The management node of claim 9, wherein the distance analysis comprises a Levenshtein algorithm.

15. The management node of claim 9, wherein the cluster analysis comprises one of a Gaussian-means cluster and an affinity propagation.

16. A method comprising:
retrieving workload attributes associated with a plurality of workloads running in a virtualized computing environment;
performing a distance analysis using the retrieved workload attributes to generate a distance matrix that identifies a distance between each workload and each other workload of the plurality of workloads;
performing a cluster analysis on the plurality of workloads based on the distance matrix to generate a plurality of clusters, each cluster comprising identical workloads from the plurality of workloads; and
associating the identical workloads in each cluster with at least one security policy to provide security services in the virtualized computing environment.

17. The method of claim 16, further comprising:
applying the at least one security policy to the identical workloads in each cluster.

18. The method of claim 16, wherein each of the plurality of workloads comprises one of a virtual machine and a container.

19. The method of claim 16, wherein the workload attributes correspond to parameters selected from a group consisting of workload parameters, operating system parameters, applications running inside workloads, and partner provided attributes for workloads.

20. The method of claim 16, wherein the distance analysis comprises a Levenshtein algorithm.

21. The method of claim 16, wherein the cluster analysis comprises one of a Gaussian-means cluster and an affinity propagation.

22. The method of claim 16, wherein each cluster comprising the identical workloads with similar configurations based on the workload attributes.

23. The method of claim 16, further comprising:
monitoring the workload attributes associated with the plurality of workloads; and
when there is a change in a workload attribute associated with a workload, reevaluating the at least one security policy associated with the workload by repeating the steps of performing the distance analysis and the cluster analysis to determine a cluster in which the workload to be grouped based on the change in the workload attribute.
